(19) United States
(12) Patent Application Publication
(10) Pub. No.: US 2025/0335652 A1
(43) Pub. Date: Oct. 30, 2025

(54) OPERATING A MICRO-GRID USING RULE-BASED CONTROLS AND A SITE-SPECIFIC OPTIMIZER

(71) Applicant: Caterpillar Inc., Peoria, IL (US)

(72) Inventors: Srideep Chatterjee, Pradesh (IN); Ranjay Singh, Pradesh (IN); Ayush Sharan, Bengaluru (IN); Manoj Kumar Bantupalli, Vizianagaram (IN)

(21) Appl. No.: 18/647,947

(22) Filed: Apr. 26, 2024

(51) Int. Cl. G06F 30/20; G06F 113/04; G06F 119/06; H02J 3/38

(52) U.S. Cl. CPC G06F 30/20; H02J 3/38; G06F 2113/04; G06F 2119/06; H02J 2203/20

(57) ABSTRACT

The system obtains a load required by a power grid and specifications of power sources. The specification indicates an amount of power that the power source can provide. The system obtains rules indicating a first power source based on the load, where the rules indicate a first power level of the first power source. The system provides the first power and level to an optimizer to determine a second power source and level by optimizing operation of the power source. The system obtains a time threshold and, based on the threshold, obtains the second power source and level from the optimizer. The system determines whether the first power source and level or the second power source and level are closer to a desired operation. Based on the determination, the system operates the first power source at the first power level or the second power source at the second power level.

### TECHNICAL FIELD

The present application is related to operating a power source in a power grid based on a combination of rule-based controls and a site-specific optimizer.

### BACKGROUND

Microgrids are decentralized power systems that consist of distributed energy resources such as renewable energy sources, energy storage systems, and conventional generators. Microgrid controllers are systems that enable the effective coordination of microgrid components such as distributed energy sources that can be either renewable or conventional energy sources, energy storage systems, and loads. Current microgrid controllers either do not yield the most optimal result and may have limited customizability to a specific site or can be computationally expensive and may suffer from convergence issues.

While application WO 2023/033783 A1 discloses determining location and sizing of a new power unit within a current system architecture of a power system or a grid, the application does not deal with resource consumption, reliability, cost, and/or carbon emissions by operating a power source in a power grid based on a combination of rule-based controls and a site-specific optimizer.

### SUMMARY

The disclosed system obtains an indication of a load required by a power grid operating at a geographical site and multiple specifications of multiple power sources providing power to the power grid. A specification among the multiple specifications is associated with a power source among the multiple power sources and indicates an amount of power that the power source can provide to the power grid, such as a range of power from the minimum amount of power to the maximum amount of power.

The system obtains a set of rules configured to indicate one or more power sources A among the multiple power sources to operate to provide power to the power grid based on the indication of the load required by the power grid. The output of the set of rules indicates one or more power levels A associated with the one or more power sources A. The set of rules is independent of the site, i.e., is not site-specific.

Based on the set of rules and the multiple specifications of multiple power sources, the system determines the one or more power sources A and the one or more power levels A and provides the one or more power sources A and the one or more power levels A to an optimizer configured to determine one or more power sources B and one or more power levels B associated with the one or more power sources B by optimizing the attribute associated with the site, while meeting the load requirement. The attribute associated with the site indicates a desired operation associated with the one or more power sources and can include resource consumption, reliability, cost, and/or carbon emissions.

Effectively, the system contains a rules-based control that simultaneously provides different power levels for operating the multiple power sources to achieve a certain goal (carbon emission, cost reduction, reliability, etc). The optimizer attempts to improve upon this by giving a new set of power levels for operating the multiple power sources. In other words, the system can simultaneously command a photovoltaic to operate at 200 kilowatts (KW), generator set to operate at 100 KW, wind turbine at 150 KW, energy storage system (ESS) to charge at 50 KW, etc.

The system obtains a time threshold. Based on the time threshold, the system obtains the one or more power sources B and the one or more power levels B from the optimizer. The system determines whether the power source A and the power level A or the power source B and the power level B are closer to the desired operation associated with the power source. Upon determining that the power source A and the power level A are closer to the desired operation associated with the power source, the system operates the power source A at the power level A suggested by the set of rules, while ignoring the power source B and the power level B. Upon determining that the power source B and the power level B are closer to the desired operation associated with the power source, the system operates the power source B at the power level B suggested by the optimizer.

### BRIEF DESCRIPTION OF THE DRAWINGS

FIG. 1 shows an overview of the system to control how much power each power source provides the power grid.

FIG. 2 shows operation of the system in more detail.

FIG. 3 shows a specification of the desired operation.

FIGS. 4A-4B show a flowchart of a method to determine an operation of a power source operating on a power grid using a combination of rule-based controls and a site-specific optimizer.

FIG. 5 is a block diagram that illustrates an example of a computing system 500 in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

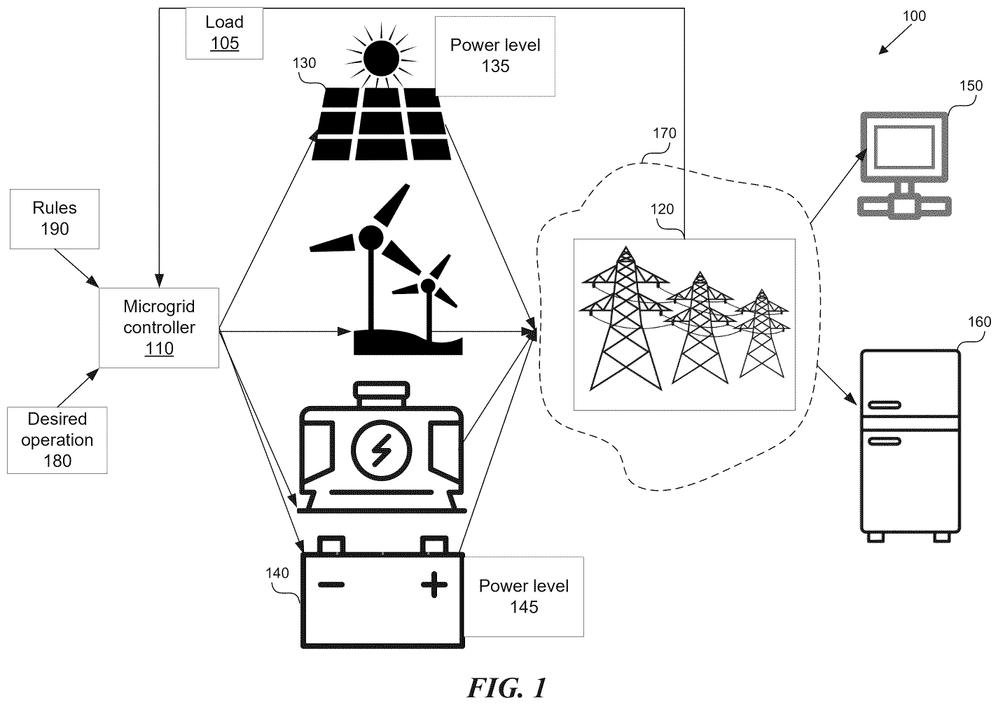

FIG. 1 shows an overview of the system to control how much power each power source provides to the power grid. The system 100 can include a microgrid controller 110, a power grid 120, and various power sources 130, 140.

The power sources 130 can be free of carbon emission and can include a wind power source, e.g., turbine, a solar power source, e.g., a solar cell, etc. The power source 140 can include power sources associated with carbon emissions such as a gasoline-powered generator, natural gas-powered generator etc.

The microgrid controller 110 can obtain an indication of a load 105 required by the power grid 120. The power grid 120 can operate at a site 170, e.g., a geographical location. The indication of the load 105 can be expressed as an amount of electricity needed by the power grid 120, which indicates an amount of power needed by consumers 150, 160 connected to the power grid 120. The consumers 150, 160 can be buildings, mine sites, electric machines/vehicles, and can vary based on the site 170.

In addition to the load 105, the microgrid controller 110 can obtain a set of rules 190 indicating which power source 130, 140 to operate and site-specific desired operation 180 of the power sources 130, 140. The desired operation 180 can vary based on the site 170 and can indicate whether carbon emissions associated with the power source 130, 140, reliability of the power source, or the cost to operate the power source is more important. Based on the load 105, the set of rules 190, and the site-specific desired operation 180, the microgrid controller 110 can select which power source 130, 140 and at what power level 135, 145, respectively, to operate.

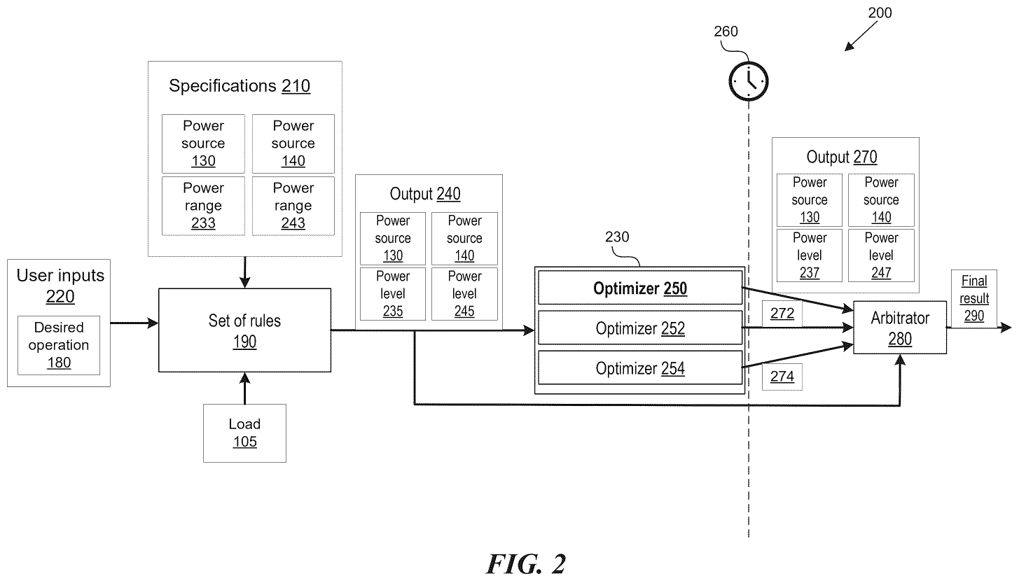

FIG. 2 shows operation of the system in more detail. The system 200 can obtain multiple specifications 210 associated with the multiple power sources 130, 140 in FIG. 1. The multiple specifications 210 can indicate a power source 130, 140 and a range of power 233, 243 that each corresponding power source 130, 140 can provide. For example, the range of power 233 can indicate that the power source 130 can operate between 0 and 100 kilowatts (KW).

Further, the system 200 can obtain the load 105 required by the power grid 120 in FIG. 1 and multiple user inputs 220 describing the desired operation 180 at the site 170 in FIG. 1. The multiple user inputs 220 can be configured through a user interface.

The system 200 can include a set of rules 190 that implements a heuristic control scheme working in tandem with an optimizer-based control scheme 230 governed by the desired operation 180. The output 240 of the set of rules 190 can indicate which power source 130, 140 should work at which power level 235, 245.

The set of rules 190 can be defined independent of the site-specific preferences. The set of rules 190 can include a rule that must be satisfied and rules that may or may not be satisfied. For example, a rule that must be satisfied can indicate that the requested load 105 is provided by the power sources 130, 140. Another rule can specify to utilize all the power from the noncarbon emitting power sources 130 prior to obtaining power from the power sources 140 associated with carbon emissions.

A third rule can specify which power sources 140 associated with carbon emissions to use and under which criteria. Specifically, the power sources associated with carbon emissions can include a battery and a fuel-powered generator, e.g., a natural gas-powered or gasoline-powered generator. The third rule can specify that if the battery state of charge is less than 20%, then the generator should be used; otherwise, use the battery. Alternatively, the rule can specify that if the battery state of charge is greater than 90%, then the battery should be used; otherwise, use the generator.

The system 200 can provide the output 240 to the optimizer 250 as a seed to begin a search for a more optimal solution within a specified time 260. In addition, the system 200 can provide constraints to the optimizer 250, such as the load 105 required by the power grid 120 in FIG. 1, and multiple specifications 210 associated with the multiple power sources 130, 140. The specified time 260 is generally determined by the desired execution speed of the microgrid controller 110 in FIG. 1. For example, if the commands need to be sent to power sources 130, 140 every one second, then the output, i.e., rule-based solution, 240 followed by the optimizer result 270 should be available within one second.

The system 200 can obtain the amount of time needed to produce the output 240, and based on the specified time 260, and determine the amount of time left to produce the solution by the optimizer 250. After the expiration of the specified time 260, the system 200 can terminate the execution of the optimizer 250 and obtain whatever results the optimizer 250 after the expiration of the specified time. The result, i.e., the output 270, can indicate which power source 130, 140 should work at which power level 237, 247.

The system 200 can use more than one optimizer 252, 254 in parallel to find multiple results 272, 274 in the specified time 260 if enough computational power is available. The arbitrator 280 can select the final result 290 among the multiple results 240, 270, 272, 274, 240 that best matches the desired operation 180 at each time step defined by the specified time 260.

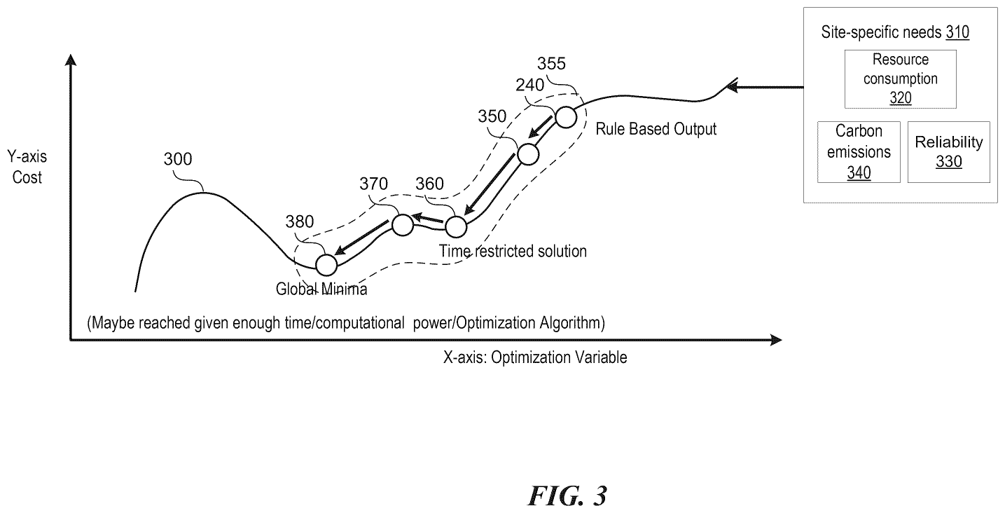

FIG. 3 shows a specification of the desired operation. The desired operation 180 in FIG. 1 can be expressed as an objective function 300 where the X-axis is the optimization variable such as a power level in which to operate a power source and the Y-axis indicates the proximity of the optimization variable to the desired operation 180. The lower the value along the Y-axis, the closer the optimization variable is to the desired operation 180. The desired operation 180 can be customized based on the site-specific needs 310, such as consumption of resources 320, reliability 330, and/or carbon emissions 340.

Consumption of a resource 320 can include fuel consumption, degradation of assets, maintenance, and cyclic degradation per kW for different assets at the site 170 in FIG. 1. For example, fuel can include natural gas or gasoline. At a particular site 170, natural gas can be abundant, and the fuel consumption may not be an issue. Therefore, the consumption of a resource 320 can have a low weight in the final output 355. Degradation of assets includes the degradation of various power sources 130, 140 in FIG. 1 during use. Maintenance of assets includes time, cost, and impact to the power grid 120 in FIG. 1 during the maintenance of the power sources 130, 140. Cyclic degradation per kW for different assets at the site 170 can include a number of times that a battery providing power to the power grid 120 is fully discharged and recharged. For example, during its lifetime, the battery can be fully discharged and recharged 10,000 times. After 10,000 times, the battery needs to be replaced. The desired operation 180 can take into account the remaining life of the battery, and the time, cost, and impact to the power grid 120 replacing the battery, and can choose to provide the power to the power grid 120 from the battery or from a different power source 130, 140.

Reliability 330 can indicate how reliable the supply of power from the power sources 130, 140 to the power grid 120 needs to be. Specifically, if the power grid 120 is operating a hospital, then the supply of power needs to be reliable all the time, and reliability 330 can outweigh any other considerations such as consumption of resources 320 and/or carbon emissions 340.

Carbon emissions 340 can indicate whether the site 170 has complied with any carbon emission limits or whether the site is associated with a preference for lower carbon emissions. If the power sources 130, 140 need to comply with a carbon emission limit, the carbon emissions 340 can have a higher influence over the final output 355 than if the site is associated with a preference for lower carbon emissions.

The output 240 from the set of rules 190 in FIG. 1 can be the starting point on the objective function 300. The optimizer 250 during its operation can use various methods such as regression optimization, gradient descent, and/or Newton optimization to traverse the objective function 300 and lower the output 240 along the Y-axis, thus approximating the desired operation 180 more closely.

During the optimizer 250 operation, the optimizer can reach various other points 350, 360, 370, 380, on the objective function 300. The point 380 represents the global minima of the objective function 300, and the optimizer 250 can provide the optimization variable values of the point 380 as the result 270 in FIG. 2. If the optimizer 250 does not reach the global minimum before the expiration of specified time 260, the system 200 in FIG. 2 can stop the operation of the optimizer 250 and obtain the best result the optimizer 250 has by that point, such as points 240, 350, 360, 370, and provide the best result as the output 270.

The advantages of the disclosed system 200 in FIG. 2, 100 in FIG. 1 is that the system guarantees a usable result 290 in FIG. 2 irrespective of the result 270, 272, 274 of the optimizer 250. For example, if the optimizer 250 has convergence or oscillation issues, the system 200 can use the rules-based result 240.

The optimizer 250 can help find the optimal solution. However, if the optimizer 250 is not able to find the global optimal solution 380 within the specified time 260, the optimizer can still provide a better result than the result 240 generated by the set of rules 190, namely points 350, 360, 370. By providing a good seed to the optimizer 250, the system 200 can also reduce the computational time of the optimizer 250. The use of the objective function 300 for the optimizer 250 can enable a broader range of customizability for different sites than is possible with a traditional rule-based controller.

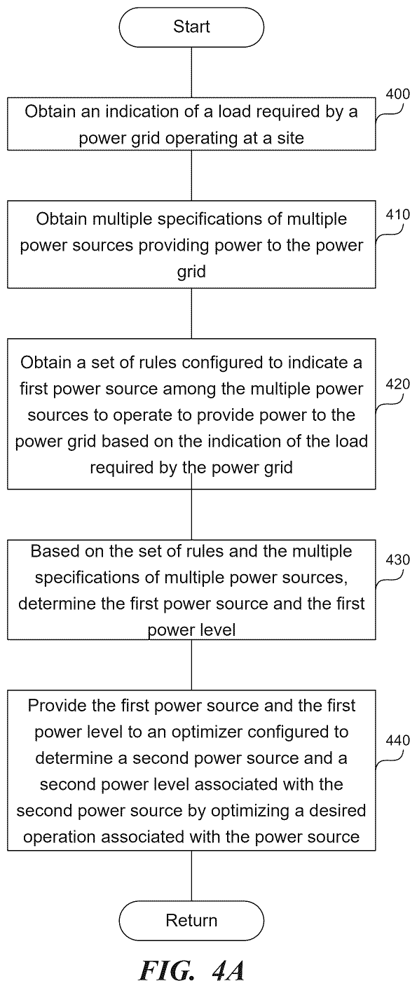

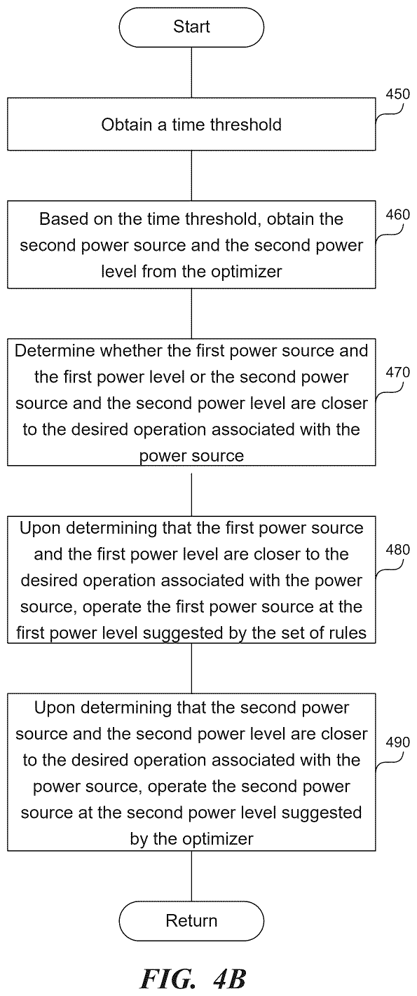

FIGS. 4A-4B show a flowchart of a method to determine an operation of a power source operating on a power grid using a combination of rule-based controls and a site-specific optimizer. A hardware or software processor executing instructions describing this application can in step 400 obtain an indication of a load required by a power grid operating at a site, such as a geographical location.

In step 410, the processor can obtain multiple specifications of multiple power sources providing power to the power grid. A specification among the multiple specifications is associated with a power source among the multiple power sources and can indicate an amount of power that the power source is configured to provide to the power grid, such as the maximum amount of power. For example, the specification can say that the particular power source, e.g., a wind turbine, can provide up to 55 KW of power. For intermittent power sources, such as wind and solar, the specification can change depending on the amount of power the power source can provide and can vary between 0 kW of power and a maximum such as 200 kW of power.

In step 420, the processor can obtain a set of rules configured to indicate a first power source among the multiple power sources to operate to provide power to the power grid based on the indication of the load required by the power grid. The output produced by the set of rules can indicate a first power level associated with the first power source. The set of rules is independent of an attribute associated with the site and may not be customized for the particular site.

In step 430, based on the set of rules and the multiple specifications of multiple power sources, the processor can determine the first power source and the first power level.

In step 440, the processor can provide the first power source and the first power level to an optimizer configured to determine a second power source and a second power level associated with the second power source by approximating an operation associated with the power source to a desired operation. The first and the second power sources can be the same power source or can be different power sources. The optimizer can have a constraint to determine the second power source and the second power level while meeting the load requirement.

In step 450, the processor can obtain a time threshold, e.g., specified time. In step 460, based on the time threshold, the processor can obtain the second power source and the second power level from the optimizer. Specifically, the processor can determine whether the time computing the output based on the set of rules and the time operating the optimizer is approaching the time threshold, such as two seconds. If the operation of the optimizer is approaching the time threshold, such as within a millisecond of the time threshold, the processor can stop the operation of the optimizer and obtain the current best result from the optimizer, namely, the second power level and the second power source.

In step 470, the processor can determine whether the first power source and the first power level or the second power source and the second power level are closer to the desired operation associated with the power source.

In step 480, upon determining that the first power source and the first power level are closer to the desired operation associated with the power source, the processor can operate the first power source at the first power level suggested by the set of rules and can ignore the second power source and the second power level.

In step 490, upon determining that the second power source and the second power level are closer to the desired operation associated with the power source, the processor can operate the second power source at the second power level suggested by the optimizer.

The processor can utilize multiple optimizers. Specifically, the processor can provide the first power source and the first power level to multiple optimizers including the optimizer. The multiple optimizers can differ in speed and accuracy and can include a regression optimizer, a gradient descent optimizer, a Newton optimizer, etc. The multiple optimizers can be configured to determine second multiplicity power sources and the second multiplicity of power levels associated with the second multiplicity of power sources by reducing a consumption of a resource. Based on the time threshold, the processor can obtain the second multiplicity of power sources and the second multiplicity of power levels from the optimizer. The processor can determine the power source based on the second multiplicity of power sources and the first power source and can determine the power level based on the second multiplicity of power levels and the first power level. The power source and the power level can be within a predetermined threshold of, e.g., closest to or within 10% of, the desired operation associated with the power source. The processor can operate the power source at the power level suggested.

The processor can provide the first power source and the first power level to the optimizer configured to determine the second power source and a second power level associated with the second power source by optimizing reliability associated with the power grid, carbon emission associated with power grid, or reducing a consumption of a resource associated with the power grid.

The processor can provide a user interface indicating the desired operation associated with the power source. The processor can obtain through the user interface a user input indicating the desired operation associated with the power source. The user input can include reliability associated with the power grid, carbon emission associated with power grid, and reducing a consumption of a resource associated with the power grid. The resource can include carbon-emitting fuel, battery life, and cost to operate the power grid.

The processor can obtain the set of rules including a first multiplicity of rules to satisfy prior to satisfying the second multiplicity of rules. The first multiplicity of rules can include a rule to satisfy the load required by the power grid and a rule to utilize a renewable power source prior to utilizing a power source associated with carbon emissions. The second multiplicity of rules can include a rule indicating criteria to use with one employing a power source associated with carbon emissions. For example, the rule can state that if the state of charge of a battery is less than 20%, then use the generator, or if the state of charge of the battery is more than 90%, then use the battery.

### INDUSTRIAL APPLICABILITY

In the disclosed system a rule-based solver can be used with an optimizer algorithm to generate a more optimal solution. The rule-based solver generates an output, which acts as input to the optimization algorithm. The optimization algorithm is configured to generate final command to control the microgrid controller. Further, when more than one optimization algorithm is used, the system can select the best solution based on a cost function.

Specifically, a rule-based (heuristic) control scheme works in tandem with optimizer-based control scheme, governed by a site-configurable cost function. The rule-based (heuristic) solution is used to find initial command to control the microgrid. This rule-based solution is already a valid solution that can be commanded to the assets. The proposed solution improves upon this command by cascading this result to an optimization algorithm.

The rule-based solution is used as a seed for an optimization algorithm to find a more optimal solution. The optimization algorithm is allowed to find a more optimal solution within a specified time. The specified time is generally determined by the desired execution speed of the controller. For example, if the desired execution speed of the controller is 1 second, then the rule-based solution followed by the optimization algorithm solution is available within 1 second.

More than one optimization algorithm may be used in parallel to find the most optimal solution in the specified time frame if enough computational power is available. At each time step the best solution among the optimization algorithms and the rule-based solver is selected from among all the solutions. Objective function and constraints for optimization algorithms can be customized based on site-specific needs. i.e. coefficients in a cost function will depend on: fuel cost, degradation costs, maintenance costs, cyclic cost per kW for different assets at the site; modes of operation like economic, reliability and emissions; and site specific regulations.

The disclosed system can find the globally optimal solution for a microgrid controller. Since the initial solution is provided by a rule-based solver, the system guarantees a usable result irrespective of the result of the optimization algorithm. For example, if the optimization algorithm has convergence or oscillation issues, the system can use the rules-based result.

The optimizer can find the globally optimal solution. However, if the optimizer is not able to find the globally optimal solution within the specified time, the system can still provide a more optimal result than the rule-based solver that can be commanded.

By providing a good seed to the optimization algorithm, the system is able to reduce the computational time of the optimization algorithm. The use of a cost function for the optimization algorithm can enable a broader range of customizability for different sites than possible with a traditional rule-based controller.

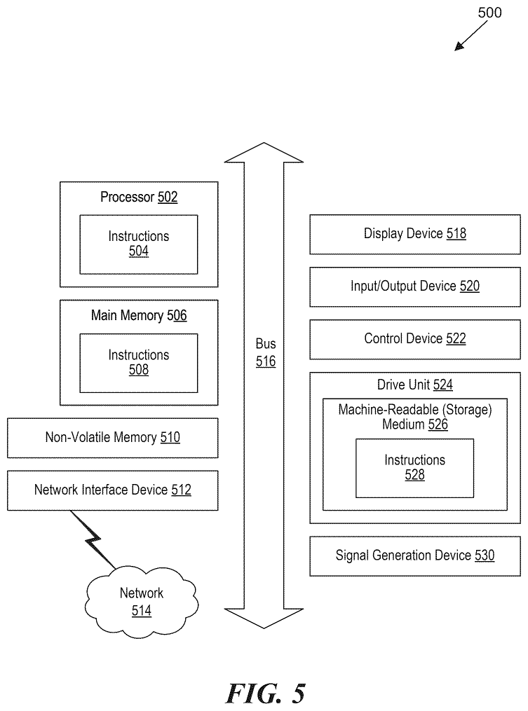

FIG. 5 is a block diagram that illustrates an example of a computing system 500 in which at least some operations described herein can be implemented. As shown, the computing system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computing system 500 is intended to illustrate a hardware device on which components illustrated or described relative to the examples of the figures and any other components described in this specification can be implemented.

The computing system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), augmented reality/virtual reality AR/VR system (e.g., head-mounted display), or any electronic device capable of executing a set of instructions that specify action(s) to be taken by the computing system 500. In some implementations, the computing system 500 can be an embedded computer system, a system-on-chip (SOC), a single-board computer (SBC) system, or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable (storage) medium 526) can be local, remote, or distributed. Although shown as a single medium, the machine-readable (storage) medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable (storage) medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

I/We claim:

1. A non-transitory, computer-readable storage medium comprising instructions recorded thereon, wherein the instructions, when executed by at least one data processor of a system, cause the system to:
obtain an indication of a load required by a power grid operating at a site;
obtain multiple specifications of multiple power sources providing power to the power grid,
wherein a specification among the multiple specifications is associated with a power source among the multiple power sources,
wherein the specification indicates an amount of power that the power source is configured to provide to the power grid;
obtain a set of rules configured to indicate a first power source among the multiple power sources to operate to provide power to the power grid based on the indication of the load required by the power grid,
wherein the set of rules indicates a first power level associated with the first power source, and
wherein the set of rules is independent of an attribute associated with the site;
based on the set of rules and the multiple specifications of the multiple power sources, determine the first power source and the first power level;
provide the first power source and the first power level to an optimizer configured to determine a second power source and a second power level associated with the second power source by optimizing the attribute associated with the site,
wherein the attribute associated with the site indicates a desired operation associated with the power source;
obtain a time threshold;
based on the time threshold, obtain the second power source and the second power level from the optimizer;
determine whether the first power source and the first power level or the second power source and the second power level are closer to the desired operation associated with the power source;
upon determining that the first power source and the first power level are closer to the desired operation associated with the power source, operate the first power source at the first power level suggested by the set of rules; and
upon determining that the second power source and the second power level are closer to the desired operation associated with the power source, operate the second power source at the second power level suggested by the optimizer.

2. The non-transitory, computer-readable storage medium of claim 1, comprising instructions to:
provide the first power source and the first power level to multiple optimizers including the optimizer,
wherein the multiple optimizers differ in speed and accuracy,
wherein the multiple optimizers are configured to determine a second multiplicity of power sources and a second multiplicity of power levels associated with the second multiplicity of power sources by reducing a consumption of a resource;
based on the time threshold, obtain the second multiplicity of power sources and the second multiplicity of power levels from the multiple optimizers;
determine the power source based on the second multiplicity of power sources and the first power source;
determine a power level based on the second multiplicity of power levels and the first power level,
wherein the power source and the power level are within a predetermined threshold of the desired operation associated with the power source; and
operate the power source at the power level.

3. The non-transitory, computer-readable storage medium of claim 1, comprising instructions to:
provide the first power source and the first power level to the optimizer configured to determine the second power source and the second power level associated with the second power source by optimizing reliability associated with the power grid, carbon emission associated with the power grid, or reducing a consumption of a resource associated with the power grid.

4. The non-transitory, computer-readable storage medium of claim 1, comprising instructions to:
provide a user interface indicating the desired operation associated with the power source;
obtain through the user interface a user input indicating the desired operation associated with the power source,
wherein the user input includes reliability associated with the power grid, carbon emission associated with power grid, and reducing a consumption of a resource associated with the power grid.

5. The non-transitory, computer-readable storage medium of claim 1, comprising instructions to:
obtain the set of rules including a first multiplicity of rules to satisfy prior to satisfying a second multiplicity of rules,
wherein the first multiplicity of rules includes a rule to satisfy the load required by the power grid and a rule to utilize a renewable power source prior to utilizing a power source associated with carbon emissions,
wherein the second multiplicity of rules includes an indication of the power source associated with carbon emissions.

6. The non-transitory, computer-readable storage medium of claim 1, comprising instructions to:
obtain the set of rules including:
a rule to satisfy the load required by the power grid;
a rule to utilize a renewable power source prior to utilizing a power source associated with carbon emissions; and
a rule indicating the power source associated with carbon emissions.

7. The non-transitory, computer-readable storage medium of claim 1, comprising instructions to:
provide a user interface indicating the desired operation associated with the power source; and
obtain through the user interface a user input indicating the desired operation associated with the power source,
wherein the user input includes reliability associated with the power grid, carbon emission associated with the power grid, and reducing a consumption of a resource associated with the power grid,
wherein the resource includes carbon-emitting fuel, battery life, and cost to operate the power grid.

8. A method comprising:
obtaining an indication of a load required by a power grid operating at a site;
obtaining multiple specifications of multiple power sources providing power to the power grid,
wherein a specification among the multiple specifications is associated with a power source among the multiple power sources,
wherein the specification indicates an amount of power that the power source is configured to provide to the power grid;
obtaining a set of rules configured to indicate a first power source among the multiple power sources to operate to provide power to the power grid based on the indication of the load required by the power grid,
wherein the set of rules indicates a first power level associated with the first power source;
based on the set of rules and the multiple specifications of the multiple power sources, determining the first power source and the first power level;
providing the first power source and the first power level to an optimizer configured to determine a second power source and a second power level associated with the second power source by approximating an operation associated with the power source to a desired operation;
obtaining a time threshold;
based on the time threshold, obtaining the second power source and the second power level from the optimizer;
determining whether the first power source and the first power level or the second power source and the second power level are closer to the desired operation associated with the power source;
upon determining that the first power source and the first power level are closer to the desired operation associated with the power source, operating the first power source at the first power level suggested by the set of rules; and
upon determining that the second power source and the second power level are closer to the desired operation associated with the power source, operating the second power source at the second power level suggested by the optimizer.

9. The method of claim 8, comprising:
providing the first power source and the first power level to multiple optimizers including the optimizer,
wherein the multiple optimizers differ in speed and accuracy,
wherein the multiple optimizers are configured to determine a second multiplicity of power sources and a second multiplicity of power levels associated with the second multiplicity of power sources by reducing a consumption of a resource;
based on the time threshold, obtaining the second multiplicity of power sources and the second multiplicity of power levels from the multiple optimizers;
determining the power source based on the second multiplicity of power sources and the first power source;
determining a power level based on the second multiplicity of power levels and the first power level,
wherein the power source and the power level are within a predetermined threshold of the desired operation associated with the power source; and
operating the power source at the power level.

10. The method of claim 8, comprising:
providing the first power source and the first power level to the optimizer configured to determine the second power source and the second power level associated with the second power source by optimizing reliability associated with the power grid, carbon emission associated with the power grid, or reducing a consumption of a resource associated with the power grid.

11. The method of claim 8, comprising:
providing a user interface indicating the desired operation associated with the power source; and
obtaining through the user interface a user input indicating the desired operation associated with the power source,
wherein the user input includes reliability associated with the power grid, carbon emission associated with the power grid, and reducing a consumption of a resource associated with the power grid.

12. The method of claim 8, comprising:
obtaining the set of rules including:
a rule to satisfy the load required by the power grid;
a rule to utilize a renewable power source prior to utilizing a power source associated with carbon emissions; and
a rule indicating the power source associated with carbon emissions.

13. The method of claim 8, comprising:
providing a user interface indicating the desired operation associated with the power source; and
obtaining through the user interface a user input indicating the desired operation associated with the power source,
wherein the user input includes reliability associated with the power grid, carbon emission associated with the power grid, and reducing a consumption of a resource associated with the power grid,
wherein the resource includes carbon-emitting fuel, battery life, and cost to operate the power grid.

14. A system comprising:
at least one hardware processor; and
at least one non-transitory memory storing instructions, which, when executed by the at least one hardware processor, cause the system to:
obtain an indication of a load required by a power grid operating at a site;
obtain multiple specifications of multiple power sources providing power to the power grid,
wherein a specification among the multiple specifications is associated with a power source among the multiple power sources,
wherein the specification indicates an amount of power that the power source is configured to provide to the power grid;
obtain a set of rules configured to indicate a first power source among the multiple power sources to operate to provide power to the power grid based on the indication of the load required by the power grid, wherein the set of rules indicates a first power level associated with the first power source;
based on the set of rules and the multiple specifications of the multiple power sources, determine the first power source and the first power level;
provide the first power source and the first power level to an optimizer configured to determine a second power source and a second power level associated with the second power source by approximating an operation associated with the power source to a desired operation associated with the power source;
obtain a time threshold;
based on the time threshold, obtain the second power source and the second power level from the optimizer;
determine whether the first power source and the first power level or the second power source and the second power level are closer to the desired operation associated with the power source;
upon determining that the first power source and the first power level are closer to the desired operation associated with the power source, operate the first power source at the first power level suggested by the set of rules; and
upon determining that the second power source and the second power level are closer to the desired operation associated with the power source, operate the second power source at the second power level suggested by the optimizer.

15. The system of claim 14, comprising instructions to:
provide the first power source and the first power level to multiple optimizers including the optimizer,
wherein the multiple optimizers differ in speed and accuracy,
wherein the multiple optimizers are configured to determine a second multiplicity of power sources and a second multiplicity of power levels associated with the second multiplicity of power sources by reducing a consumption of a resource;
based on the time threshold, obtain the second multiplicity of power sources and the second multiplicity of power levels from the multiple optimizers;
determine the power source based on the second multiplicity of power sources and the first power source;
determine a power level based on the second multiplicity of power levels and the first power level,
wherein the power source and the power level are within a predetermined threshold of the desired operation associated with the power source; and
operate the power source at the power level.

16. The system of claim 14, comprising instructions to:
provide the first power source and the first power level to the optimizer configured to determine the second power source and the second power level associated with the second power source by optimizing reliability associated with the power grid, carbon emission associated with the power grid, or reducing a consumption of a resource associated with the power grid.

17. The system of claim 14, comprising instructions to:
provide a user interface indicating the desired operation associated with the power source; and
obtain through the user interface a user input indicating the desired operation associated with the power source,
wherein the user input includes reliability associated with the power grid, carbon emission associated with the power grid, and reducing a consumption of a resource associated with the power grid.

18. The system of claim 14, comprising instructions to:
obtain the set of rules including a first multiplicity of rules to satisfy prior to satisfying a second multiplicity of rules,
wherein the first multiplicity of rules includes a rule to satisfy the load required by the power grid and rule to utilize a renewable power source prior to utilizing a power source associated with carbon emissions,
wherein the second multiplicity of rules includes an indication of the power source associated with carbon emissions.

19. The system of claim 14, comprising instructions to:
obtain the set of rules including:
a rule to satisfy the load required by the power grid;
a rule to utilize a renewable power source prior to utilizing a power source associated with carbon emissions; and
a rule indicating the power source associated with carbon emissions.

20. The system of claim 14, comprising instructions to:
provide a user interface indicating the desired operation associated with the power source; and
obtain through the user interface a user input indicating the desired operation associated with the power source,
wherein the user input includes reliability associated with the power grid, carbon emission associated with the power grid, and reducing a consumption of a resource associated with the power grid,
wherein the resource includes carbon-emitting fuel, battery life, and cost to operate the power grid.
